(19) United States
(12) Patent Application Publication
(10) Pub. No.: US 2007/0001053 A1
(43) Pub. Date: Jan. 4, 2007

(54) Layered shell vacuum balloons

(76) Inventors: Andrey M. Akhmeteli, Torrance, CA (US); Andrey V. Gavrilin, Tallahassee, FL (US)

Correspondence Address: Pennington, Moore, Wilkinson, Bell & Dunbar, P.A.;2nd Floor, 215 S. Monroe Street, P.O. Box 10095, Tallahassee, FL, 32302-2095, US

(21) Appl. No.: 11/517,915

(22) Filed: Sep. 8, 2006

Related U.S. Application Data
(63) Continuation-in-part of application No. 11/127,613, filed on May 12, 2005, now abandoned.
(60) Provisional application No. 60/570,753, filed on May 13, 2004.

(51) Int. Cl. B64B 1/02

(52) U.S. Cl. 244/125

(57) ABSTRACT

A new type of vacuum balloon. A layered wall structure is used, including a relatively thick honeycombed section sandwiched between and bonded to two relatively thin layers. This layered wall design is used to form a thin-walled sphere having greatly enhanced resistance to buckling. Using this approach it is possible, with existing materials, to create a rigid vacuum balloon having positive buoyancy.

### MICROFICHE APPENDIX

Not Applicable

### BACKGROUND OF THE INVENTION

1. Field of the Invention

This invention relates to the field of lighter-than-air structures. More specifically, the invention comprises a rigid “balloon” having a layered shell comprised of specified materials and dimensions. The selection of appropriate materials and dimensions allows the balloon to simultaneously achieve sufficient compressive strength, buckling stability, and positive buoyancy.

2. Description of the Related Art

The concept of using a rigid evacuated shell as a lifting device is several centuries old. Lift is created by evacuating a weight of air which is greater than the weight of the structure of the shell itself, thereby creating a “vacuum balloon.” Of course, the structure must be able to resist the compressive forces exerted by the surrounding atmosphere. A simple analysis of these forces illustrates why the concept of a vacuum balloon has not been realized in fact.

FIG. 1 shows a vacuum balloon 8 (sectioned in half to illustrate its hollow nature). One-layer shell 10 is a thin spherical structure of homogenous material. FIG. 2 shows a closer view of the wall of one layer shell 10. The thickness of the shell material is designated as h.

Returning to FIG. 1, a simple stress analysis is discussed using one half of the shell. The atmospheric pressure, Pₐ, exerts force uniformly across the surface area of a spherical shell. In the view, the sphere has been sectioned in half in order to simplify the analysis.

If R is the overall radius of the shell, and Pₐ is the atmospheric pressure, then the total force exerted upon the half of the shell by the atmospheric pressure is π·R²·Pₐ. The half of the shell will be in static equilibrium if this force is balanced by the total compressive force in analyzed section 11 (graphically depicted as the six smaller arrows in the view).

The approximate surface area for analyzed section 11 is 2·π·R·h (very nearly true for a thin-walled sphere, as shown). The compressive stress in analyzed section 11 is therefore found by the expression:
σ=(π·R²·Pₐ)/(2·π·R·h)

Of course, the ultimate goal is to obtain buoyancy. In order to obtain neutral buoyancy, the mass of the shell must be no greater than the mass of the air it displaces. The volume of air displaced is equal to 4/3·π·R³. The mass of the displaced air is therefore 4/3·π·R³·ρₐ, where ρₐ is the density of the air.

The volume of the shell material is equal to 4·π·R²·h. The mass of the shell material is then equal to 4·R²·h·ρₛ, where ρₛ is the density of the shell material. Setting the mass of the displaced air equal to the mass of the shell material gives the following expression:
4/3·π·R³·ρₐ=4·π·R²·h·ρₛ (Equation 1)

Cancelling out factors found on both sides of the expression simplifies the equation to:
h/R=ρₐ/(3·ρₛ)

A form suitable for substitution back into the prior equation for σ is then stated as:
h=(ρₐ·R)/(3·ρₛ)

Substituting in this expression gives the following solution for the simple stress in analyzed section 11:
σ= 3/2·(ρₛ/ρₐ)·Pₐ

This expression can be used to evaluate the compressive stress in an aluminum shell thin enough to obtain neutral buoyancy. The density of aluminum (ρₛ) is about 2700 kg/m³. The density of air at normal conditions (ρₐ) is about 1.29 kg/m³. Atmospheric pressure is about 1.01·10⁵ Pa. Thus, using the simple stress equation, the compressive stress in the thin aluminum shell is about 3.2·10⁸ Pa. This value is of the same order of magnitude as the compressive strength of good modern aluminum alloys.

However, those skilled in the art will realize that a simple evaluation of the compressive stress in analyzed section 11 is insufficient to predict the resistance of the thin shell to compression when evacuated. Thin shells typically fail by buckling (loss of stability). The critical buckling pressure (P_{cr}) for a thin walled shell is determined using the following formula of the linear theory of stability:

$${P}_{cr} = \frac{2 \cdot E \cdot {h}^{2}}{\sqrt{3 \cdot ( 1 - {μ}^{2} )}} \cdot \frac{1}{{R}^{2}}$$

In this expression, E stands for the modulus of elasticity and μ stands for Poisson's ratio. Substituting in the prior expression h=(ρₐ·R)/(3·ρₛ) and solving for the ratio of (E/ρₛ²) gives the following expression:

$$E / {ρ}_{s}^{2} = \frac{9 \cdot {P}_{cr} \cdot \sqrt{3 \cdot ( 1 - {μ}^{2} )}}{2 \cdot {ρ}_{a}^{2}}$$

If the expression is solved for atmospheric pressure (P_{cr}=Pₐ), then one can determine if a suitable material (with a sufficiently high modulus of elasticity and a sufficiently low density) is available. Using a Poisson's ratio of 0.3 (a representative value) allows for the solution of E/ρₛ². The solution is about 4.5·10⁵ kg⁻¹·m⁵·s⁻².

This figure suggests that a phenomenally stiff and light material will be needed. If, as an example, diamond is used as the shell material (modulus of elasticity of 1.2·10¹² Pa and density of 3500 kg/m³), then the ratio E/ρₛ² will be about 1·10⁵ kg⁻¹·m⁵·s⁻². Thus, even diamond is not nearly strong enough to form a vacuum balloon using a homogenous wall structure. No known material can be used to create a vacuum balloon made from a homogenous wall structure. A different structural solution is therefore needed.

The abstract concept of a vacuum balloon has been presented in several prior U.S. patents. As an example, U.S. Pat. No. 3,288,398 presents a vacuum balloon formed from a homogenous ceramic wall. The disclosure in the '398 patent presents no analysis of the proposed structure's stability when enough air is evacuated to achieve buoyancy. In fact, as discussed in the preceding section, a homogenous wall structure as disclosed in the '398 patent will fail long before positive buoyancy is achieved.

U.S. Pat. No. 1,390,745 to Armstrong discloses a composite wall structure with the suggestion that the structure can be used in creating a buoyant and rigid balloon. However, upon closer reading, the '745 disclosure has no information regarding how the proposed structure could actually achieve positive buoyancy. In fact, the '745 disclosure states that the walls “may be made as thick and strong as desired.” When the walls of the '745 design are in fact made as thick and strong as they need to be to resist collapse when the interior is evacuated, the structure comes nowhere close to positive buoyancy.

Accordingly, it is desirable to produce a composite structure in which the materials are selected to have particular properties and in which the dimensions are optimized within a range in order to achieve (1) positive buoyancy; and (2) sufficient buckling stability to maintain an acceptable safety factor.

### BRIEF SUMMARY OF THE INVENTION

The present invention comprises a new type of vacuum balloon. A layered wall structure is used, including a relatively thick cellular section sandwiched between and bonded to two relatively thin layers. Different materials are selected for the thick section versus the thin layers (In some instances they may be made from the same materials, but processed in a different way). The layered wall design is used to form a thin-walled sphere having greatly enhanced resistance to buckling. Using this approach it is possible to create a rigid vacuum balloon, having positive buoyancy, which is also strong enough to withstand atmospheric pressure.

The invention comprises defining a critical range for the relative wall thicknesses. When the defined parameters lie within this critical range, the overall structure is both stable and positively buoyant.

### BRIEF DESCRIPTION OF THE SEVERAL VIEWS OF THE DRAWINGS

FIG. 1 is a perspective view, showing a portion of a vacuum balloon.

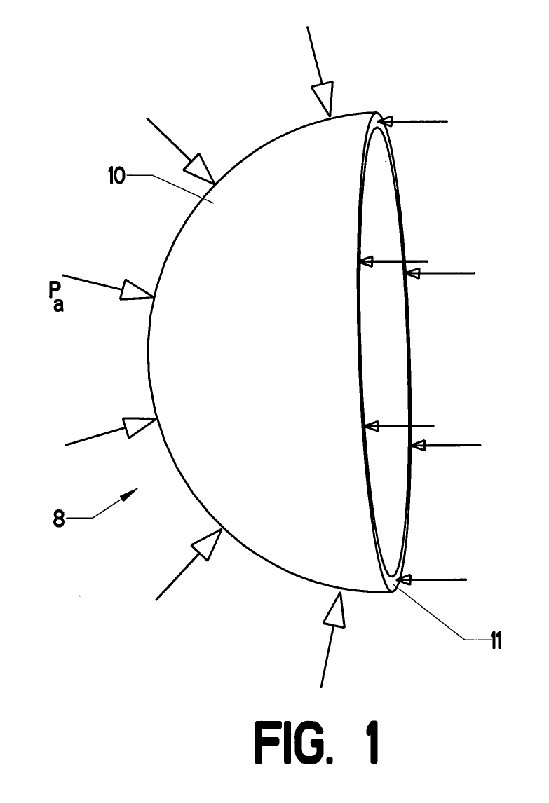

FIG. 2 is a detail view, showing a portion of the wall used in the vacuum balloon of FIG. 1.

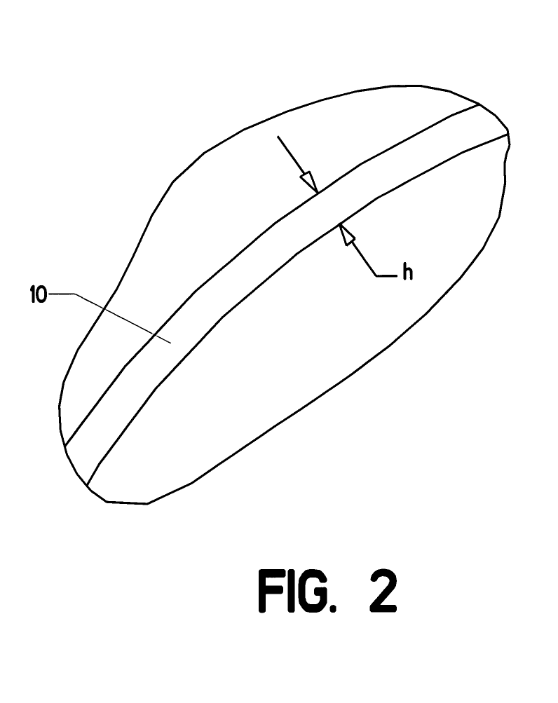

FIG. 3 is an exploded view, showing the components used to form a wall in the present invention.

FIG. 4 is a perspective view, showing the components of FIG. 3 in an assembled state.

FIG. 4B is a plan view, showing a hexagonal cell.

FIG. 5 is a perspective view, showing one possible application for the vacuum balloons.

FIG. 6 is a perspective view, showing an alternate approach to constructing a vacuum balloon.

FIG. 7 is a perspective view, showing an alternate wall construction.

FIG. 8 is a perspective view, showing the use of vents in the core layer.

FIG. 9 is a perspective view, showing an alternate embodiment using a porous foam as the core layer.

FIG. 10 is a plan view, showing individual pores in the porous foam.

FIG. 11 is a three-dimensional plot showing the relationship between the safety factor, the shell mass to displaced air mass ratio, and h₃′.

FIG. 12 is a three-dimensional plot showing the relationship between the safety factor, the shell mass to displaced air mass ratio, and h₃′.

FIG. 13 is a three-dimensional plot showing the relation ship between the safety factor, the shell mass to displaced air mass ratio, and h₃′.

FIG. 14 is a two-dimensional plot showing the relationship between safety factor and h₃′.

### REFERENCE NUMERALS IN THE DRAWINGS

8 vacuum balloon
10 one-layer shell
11 analyzed section
12 layered shell
14 inner layer
16 core layer
18 outer layer
20 layered vacuum balloon
22 fuselage
24 payload compartment
26 air ship
28 balloon half
30 mating flange
32 alternate layered shell
34 reinforcing rib
36 hexagonal cell
38 vent
40 porous foam
42 foam pore

### DETAILED DESCRIPTION OF THE INVENTION

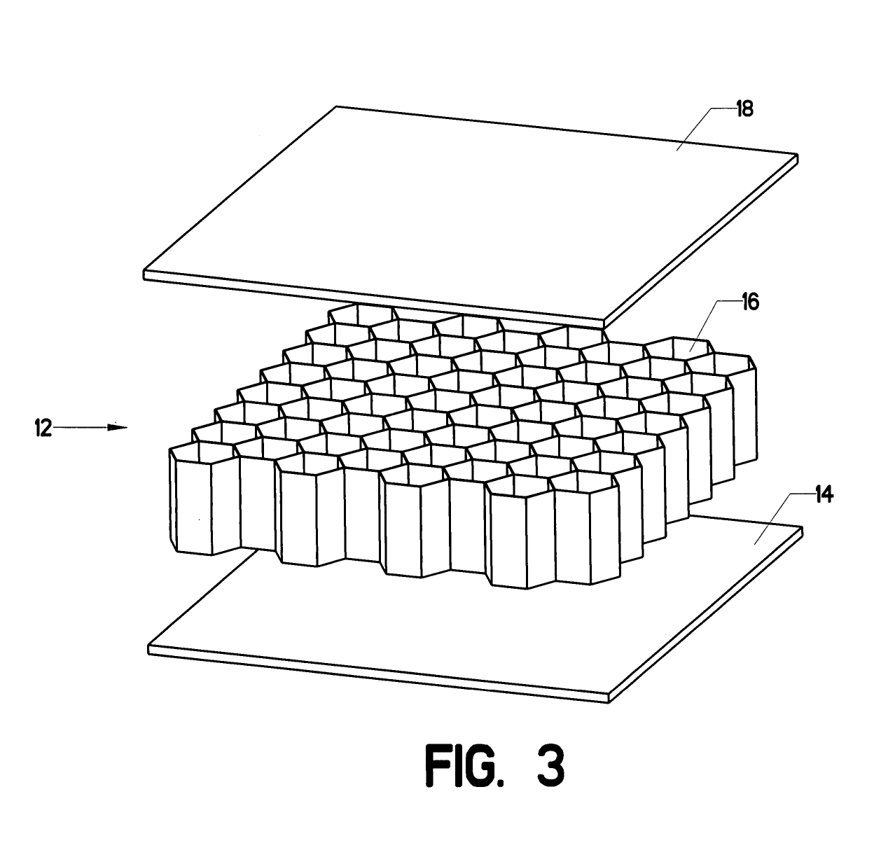

FIG. 3 shows a new type of wall section used in the present invention. Layered shell 12 is formed in the shape of a thin-walled hollow sphere. FIG. 3 shows a small portion of the wall. Inner layer 14 faces the sphere's hollow interior. Outer layer 18 covers the outside of the sphere. Sandwiched between inner layer 14 and outer layer 18 is core layer 16. These three layers are bonded together using adhesives or other known processes. Those skilled in the art will know that adhesives have been successfully used for many years in the creation of thin-walled honeycomb structures.

Core layer 16 is made of a material having the following properties:
1. low density;
2. relatively high compressive strength in the transverse (radial) direction;
3. relatively high out-of-plane shear strength;
4. relatively high compressive modulus of elasticity in the transverse (radial) direction; and
5. relatively high out-of-plane shear modulus.

One suitable core layer material is aluminum alloy honeycomb. An example is PLASCORE PAMG-XR1 1.0-3/8-0007-5056, available from Plascore, Inc., of 615 N. Fairview Street, Zeeland, Mich. 49464. Other materials can also be used, so long as they have a “cellular” structure. The term “cellular” as used herein means a heterogenous composition consisting of cells formed by rigid walls or ribs. The cells are voids in the structure. They may be open or closed. In some cases they may contain a gas such as air. As the core comprises a small part of the balloon's overall volume, the mass of the gas contained in the cells is insignificant (although its pressure may affect the compressive properties of the structure to some extent).

The inner and outer layers should be made of a material which is different from that selected for the core, since different material properties are needed (although a foam or a honeycomb matrix made of the same material as the inner and outer layers may be used as the core). Three materials were considered for inner layer 14 and outer layer 18. These were:
1. Brush Wellman I220H beryllium alloy, available from Brush Wellman, Inc., Beryllium Products Division, 14710 W. Portage River S. Road, Elmore, Ohio 43416;

2. Ceradyne Ceralloy 546-3E boron carbide ceramic, available from Ceradyne, Inc., 3169 Redhill Ave., Costa Mesa, Calif. 92626; and

3. Diamond-like carbon (“DLC”), with some typical properties.

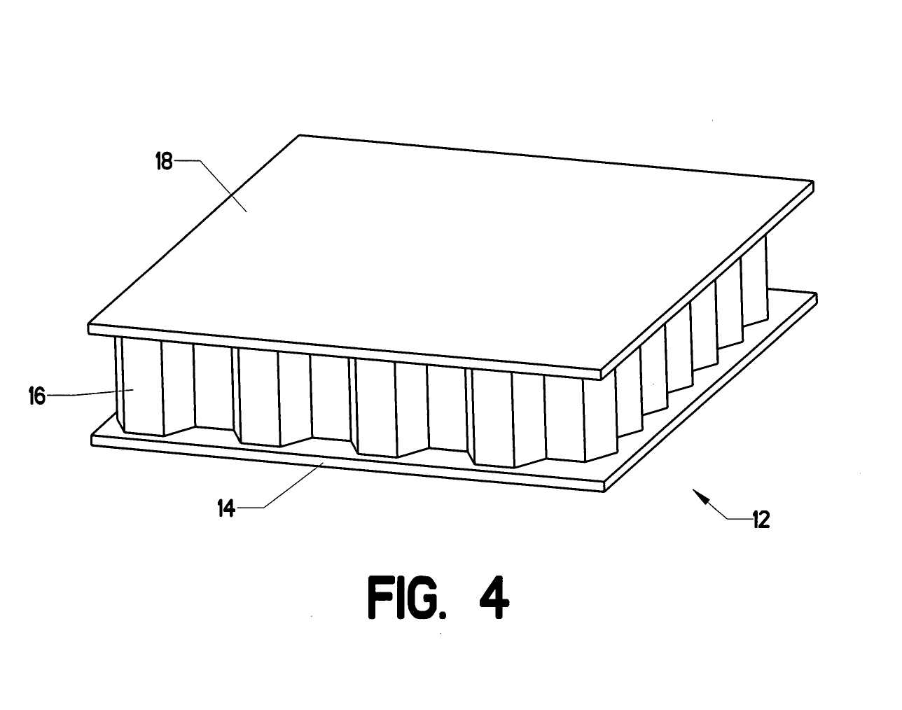

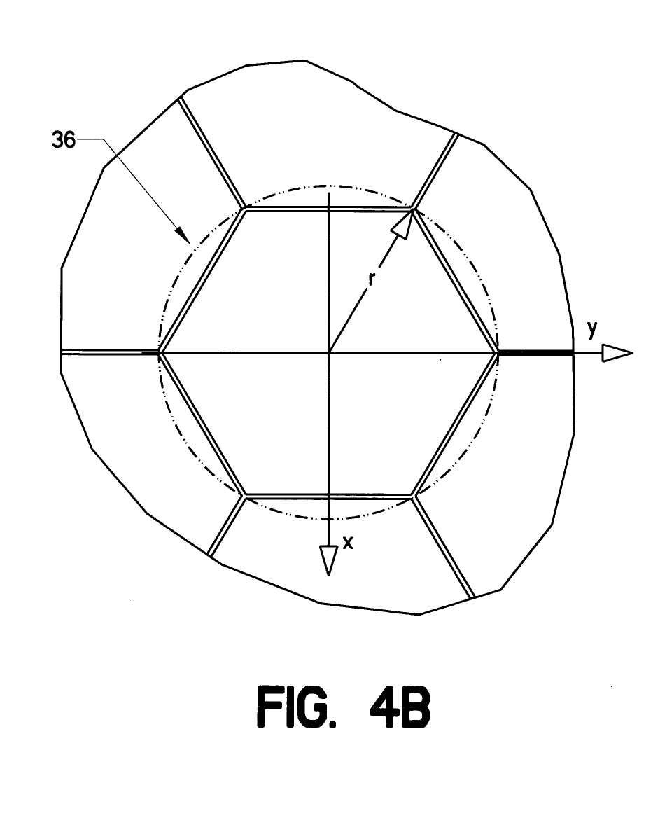

FIG. 4 shows the three layers bonded together to form layered shell 12. The reader will observe that the inner and outer layers have the same thickness, while the core layer has a significantly greater thickness.

The shell section shown in FIGS. 3 and 4 appears to be flat, but this is only because such a small portion is shown. In reality, the shell section is a portion of a spherical surface (meaning it is curved in two planes). Inner layer 14 and outer layer 18 are straightforward spherical sections. The embodiment shown in FIGS. 3 and 4 uses a honeycomb matrix for the core. Because the core material must also wrap around a spherical surface, the nature of the honeycomb material comprising core layer 16 is more complex than it would be if the matrix simply conformed to a flat surface.

The honeycomb is made from a plurality of adjoining cells, bounded by walls which join the inner layer to the outer layer. Each of these walls must be approximately parallel to a radius extending from the center of the sphere to the shell at the position of the particular wall. Thus, the honeycomb cells will curve in two planes as well. This fact holds true for all types of cells, whether they are hexagonal or not (non-hexagonal cells will be discussed subsequently).

The cellular structure for the core layer can be made using a variety of techniques, and should not be seen as limited to honeycomb cells. One possible substitute approach is described in detail in U.S. Pat. No. 5,273,806 to Lockshaw et. al. (1993). That patent, which is hereby incorporated by reference, discloses a different approach to creating interlocking cells. However, as hexagonal cells are most common, they have been illustrated in this disclosure.

Light honeycombs are usually made of thin metal foil and are relatively flexible. They may be laid upon and bonded to curved surfaces. They have been used in curved structures for many decades. For highly curved surfaces, modifications of the honeycomb are made (such as providing a cell with curved walls).

Expressions can be developed to describe the stability of the layered structure. Let h₁=h₂ equal the thickness of inner layer 14 and outer layer 18. Let h₃ be the thickness of core layer 16. Let ρₛ be the density of the inner and outer layers, and let ρ_{c} be the density of the core layer. The equilibrium condition where the mass of the structure equals the mass of the air displaced (as previously described in equation 1) can then be reformulated as follows:
4/3·π·R³·ρₐ=4·π·R²·(2·h₁·ρₛ+h₃·ρ_{c})

The buckling stability condition was previously formulated by others for a three-layer dome on a semi-empirical basis. The critical pressure is determined as follows:

$${P}_{cr} = 2 \cdot E \cdot \frac{{h}_{1} \cdot ( {h}_{3} + {h}_{1} )}{{R}^{2}} \approx 2 \cdot E \cdot \frac{{h}_{1} \cdot {h}_{3}}{{R}^{2}}$$

In this expression E is the modulus of elasticity of the inner layer and the outer layer material (assuming they are made of the same material). A different modulus of elasticity for the core material will be designated as E_{c}. The core material is typically anisotropic, meaning that its mechanical properties will not be the same for all orientations (although it may be isotropic if a foam is used as the core material). The modulus E_{c} is the modulus of elasticity in the transverse (radial) direction.

An expression is known for the critical load of the local form of instability of a three-layer plate. The expression determines the minimum stable value permissible for E_{c}:

$${E}_{c}^{( min )} = \sqrt{\frac{4 {T}_{cr}^{3}}{{E}^{′} {δ}^{3}}} , where {E}^{′} = \frac{E}{1 - {μ}^{2}} , 2 {T}_{cr}$$

is critical load per unit width of a three-layer plate, δ is the thickness of the inner layer and the outer layer, and μ is the Poisson's ratio for the material of the inner layer and the outer layer.

For the case of the relatively thin-walled hollow sphere, then, the following expression may be written:
2πR·2T_{cr}=πR²·P_{cr}, and δ=h₁.

In order to obtain the minimum shell mass, E_{c} should be set equal to E_{c}^{(min)}. A value for the minimum stable core thickness can then be determined as

$${h}_{3}^{′} = {[ \frac{{E}_{c}}{E \sqrt{\frac{1 - {μ}^{2}}{2}}} ]}^{2 / 3} , \qquad ( Equation 2 )$$

, (Equation 2), where h₃′=h₃/R.

A finite element eigenvalue buckling analysis was performed to confirm and refine the theoretical results. The honeycomb core layer was modeled as recommended by Hexcel Composites, a honeycomb manufacturer. Specifically, Poisson's ratio in all directions (μ_{xy}, μ_{xz}, μ_{yz}), “in-plane” moduli of elasticity (Eₓ, E_{y}), and “in-plane” shear modulus (G_{xy}) of the honeycombs are all zero or nearly zero (assuming that direction z is normal to the shell surface).

For a cell size of ⅜ inch and a foil thickness of 0.0007 inches, the figures provided by www.plascore.com/5056_{—}2.htm were as follows:

Nominal Density=1.0 pounds per cubic foot

Bare Compression Strength=35 psi

Bare Compression Modulus=15,000 psi

Plate Shear Strength (“L” direction)=60 psi

Plate Shear Strength (“W” direction)=35 psi

Plate Shear Modulus (“L” direction)=15,000 psi

Plate Shear Modulus (“W” direction)=9,000 psi

These values were used to analyze the layered shell. However, the honeycombs were assumed to be transversely isotropic, so the lesser values of shear strength and shear modulus were chosen. It should be noted that the difference between the honeycomb plate shear modulus and the bare shear modulus was shown by others to be about 10%.

The following relationship exists between the minimum eigenvalue obtained in the eigenvalue buckling analysis and the critical pressure:

$${λ}_{min} = \frac{{P}_{cr}}{{P}_{a}}$$

The eigenvalue λₘᵢₙ can be determined for a range of varying values of h₃′. The minimum eigenvalue, λₘᵢₙ has a rather sharp maximum for a value of h₃′ that is approximately half as large as that obtained by the simplified method of Equation 2.

The expression of Equation 2 will not provide an appropriate answer for all altitudes. Those skilled in the art will realize that a vacuum balloon can be optimized for a particular range of altitudes and that—as an example—a vacuum balloon optimized for low altitudes will not provide positive buoyancy at high altitudes. The low-altitude vacuum balloon must have relatively higher strength, and a relatively thick and heavy wall. If this vacuum balloon is then transported to high altitudes, its mass may be too great to achieve positive buoyancy (even with a very high internal vacuum).

For such a high-altitude vacuum balloon, the optimal value of h₃′ may be significantly less than the expression given in Equation 2 (as the value from Equation 2 may be too high for positive buoyancy at high altitudes). It may then be determined from the following approximate condition: The mass of the core should be roughly equal to the combined mass of the face sheets. The reader should bear in mind that these expressions provide approximate values. Whatever altitude range a vacuum balloon is optimized for, the actual optimal dimensions for the face sheets and the core can be determined using the finite element method.

For beryllium inner and outer layers (ρₛ=1850 kg/m³, E=303 GPa, μ=0.08), the maximum value for the minimum eigenvalue exceeds 3.50 (This value was obtained for h₃′≈2.77·10⁻³ and h₁′≈1.04·10⁻⁴, where h₁′=h₁/R). For boron carbide inner and outer layers (ρₛ=2500 kg/m³, E=460 GPa, μ=0.17), this maximum exceeds 3.06 (This value was obtained for h₃′≈2.36·10⁻³ and h₁′≈7.05·10⁻⁵). For diamond-like carbon (“DLC”) inner and outer layers (ρₛ=3500 kg/m³, E=700 GPa, μ=0.2) this maximum exceeds 2.56 (This value was obtained for h₃′≈1.98·10⁻³, h₁′≈5.69·10⁻⁵). The reader should note that the inner and outer layers may be made of different materials. As an example, the inner layer might be DLC while the outer layer might be boron carbide.

Of course, it is desirable for the vacuum balloon to carry a useful load, rather than merely achieving neutral buoyancy on its own. Thus, if the wall thicknesses are reduced by 30% (with the resulting weight reduction representing an available payload), a new value for λₘᵢₙ must be determined. The new figure for boron carbide inner and outer layers is 2.14, which is still significantly more than 2.

Those skilled in the art will therefore realize that existing materials can be used to make a three-layer positively buoyant vacuum balloon which can withstand atmospheric pressure (including a reasonable safety factor). Non-linear buckling analysis can be used to refine the analysis of the critical pressures, taking into account expected manufacturing imperfections. The safety factor will be eroded somewhat. However, precisely manufactured thin spherical shells were shown to withstand external pressures of up to 80-90% of the theoretical critical pressure. The static stress analysis also confirmed that the stress values within the inner layer, the core layer, and the outer layer did not exceed the respective compressive strengths for the materials used.

Intracell buckling is another factor which should be considered in evaluating the stability of the design. FIG. 4B shows hexagonal cell 36, which has a particular circumradius r. If Tₓ, T_{y} are the critical loads per unit width of the face sheet in directions x and y, then the formula for the critical intracell buckling load was previously developed by others as follows:

$${T}_{x} + 1.116 {T}_{y} = 34.878 \frac{D}{{r}^{2}} , where D = \frac{{Eh}_{1}^{3}}{12 ( 1 - {μ}^{2} )} .$$

In these expressions, E and μ are the modulus of elasticity and Poisson's ratio, respectively. of the face sheet material. The thickness of the face sheet material is represented by h₁. This is a formula for flat sandwich plates, so the convexity of the shell is neglected. This means that the estimate will be conservative, since the shell's convexity adds additional stability.

Assuming that the entire compressive stress is carried by the face sheets, and further assuming Tₓ=T_{y}=T, then 2πR·2T=πR²Pₐ, where Pₐ is the atmospheric pressure at normal conditions. The following expression may then be obtained:

$${R}^{2} = 0.182 ( 1 - {μ}^{2} ) \frac{{P}_{a} {r}^{2}}{{E ( {h}_{1}^{′} )}^{3}} ,$$

where R is the radius of the shell, and

$${h}_{1}^{′} = \frac{{h}_{1}}{R} .$$

For boron carbide, PLASCORE PAMG-XR1 1.0-3/8-0007-5056 honeycombs, with h₁′≈7.85·10⁻⁵, the value computed for R is approximately 1.56 m. Thus, for larger radii the shell will be stable against intracell buckling. It should also be noted that intracell buckling does not necessarily cause the shell to fail even if the face sheets are made of boron carbide.

The design of the present invention should be reasonably scalable. If all linear dimensions are multiplied by the same factor, the results described previously should hold. Thus, vacuum balloons of many different sizes could be fabricated.

Improved results can also be achieved by substituting different types of honeycomb materials. A stiffer and heavier honeycomb can actually improve the performance. A commercially-available honeycomb structure can be obtained from Plascore having the following properties:

Nominal density 3.1 pounds per cubic foot

Bare compression strength 340 psi

Bare compression modulus 97,000 psi

Plate shear strength (L direction) 250 psi

Plate shear strength (W direction) 155 psi

Plate shear modulus (L direction) 45,000 psi

Plate shear modulus (W direction) 20,000 psi

This material may actually be sub-optimal, but it is commercially available. A spherical structure can be made as previously described by sandwiching this type of honeycomb between two boron carbide ceramic face sheets. The wall thicknesses are then adjusted so that the evacuated sphere is positively buoyant and can actually carry a 5% payload (The mass of the structure is 5% less than the mass of the air it displaces). A safety factor of 5.42 can be achieved with this approach (for h₁′≈6.15·10⁻⁵, h₃′≈2.03·10⁻³).

The French CODAP rules for buckling require that the safety factor be at least 3.0 (“CODAP” is a French acronym for a safety code pertaining to pressure vessels). The American ASME-BPV code requires a safety factor of 5.0. Thus, under either code, the safety factor achieved is sufficient.

Those skilled in the art will know that the core layer's honeycomb structure can assume many forms as well. A series of conjoined hexagonal cells is the most common. Other shapes are possible, including cells forming the shape of a triangle or rectangle.

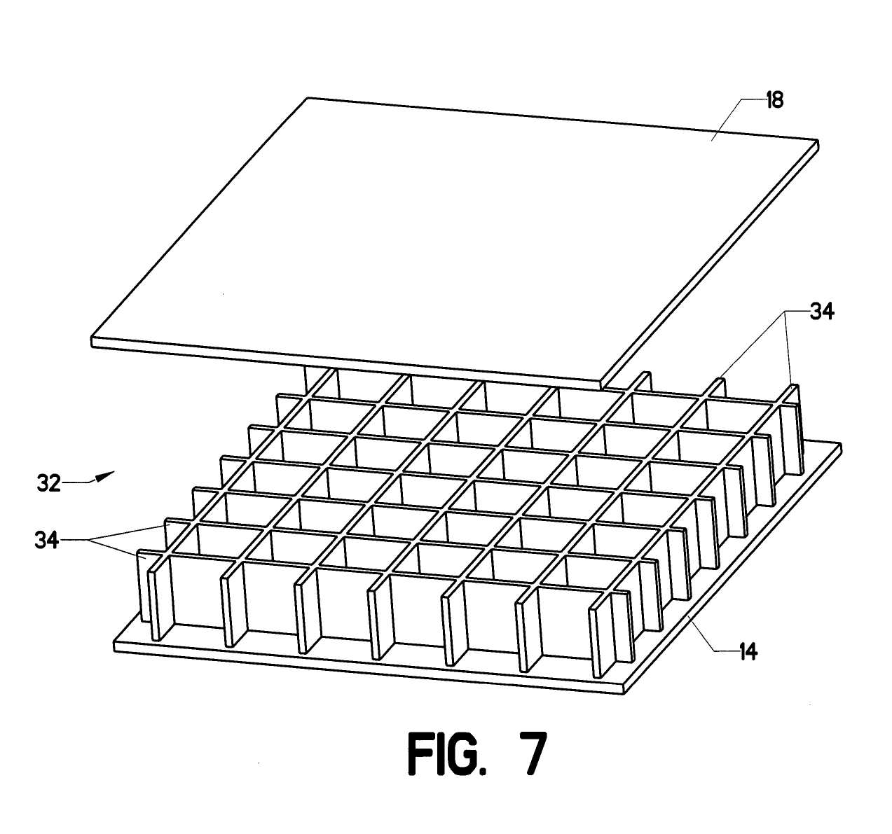

It is also possible to substitute different structures for the core layer, such as a series of reinforcing ribs. FIG. 7 shows an embodiment of such a design, denoted as alternate layered shell 32. A series of reinforcing ribs 34 are bonded to inner layer 14. Outer layer 18 is then bonded to the upper portions of the reinforcing ribs to form the layered shell. The ribs have a thickness of t and they are spaced apart a distance a. The height of the ribs corresponds to the thickness of the previously described core layer, which is designated as h₃.

The reader will by now recognize that the use of such interlocking cells forms a similar structure to the previously described honeycomb cells. It uses square cells instead of hexagonal ones. The standard linear buckling analysis of orthotropic shells performed on this alternate structure established its viability (meaning that the shell was globally stable, the ribs were stable under the resulting stress in the non-radial directions, and no intra-cell buckling of the inner and outer layers occurred).

In this example, boron carbide was selected as the material for the inner layer and outer layer (ρ=2500 kg/m³; E=460 GPa (elastic modulus); μ=0.17). The layered shell was then optimized for varying thicknesses of the inner layer, the outer layer, and the rib geometry. The optimized shell (R:h₁:a:h₃:t=1:6.67·10⁻⁵:3.40·10⁻³:1.89·10⁻³:3.48·10⁻⁵) was able to withstand pressures up to 1.90·10⁵ Pa (approximately 1.88 times atmospheric pressure).

These results suggest that using the rib structure is less efficient than using the honeycomb material for the core layer. Apparently the walls of the honeycomb matrix do not (individually) meet the requirements for stability under the resulting stress in non-radial directions. This condition does not result in structural failure, however. The weaker honeycomb core actually turns out to be more weight-efficient, meaning that it can produce a vacuum balloon having identical crush strength using less material than the ribbed design. For this reason, the embodiment using the honeycomb core layer is preferable to the square-celled embodiment.

It was mentioned previously that a cellular structure is used for the core layer. The previous examples disclosed materials having a repeated geometric structure. While these produce a viable construction, those skilled in the art will know that bonding the face sheets to the honeycomb matrix can be difficult. In addition, very small vacuum balloons (having a diameter less than 1 m) may be unstable with respect to intracell buckling (buckling of a face sheet within one cell of the honeycomb matrix). This is true because it is difficult to manufacture light honeycombs with small cells for the honeycomb matrix. Thus, a small vacuum balloon must use a relatively large cell size. In order to meet the mass constraints, however, the face sheet thickness must be quite thin. This makes the face sheet vulnerable to intracell buckling. It is therefore desirable to consider different types of cellular materials.

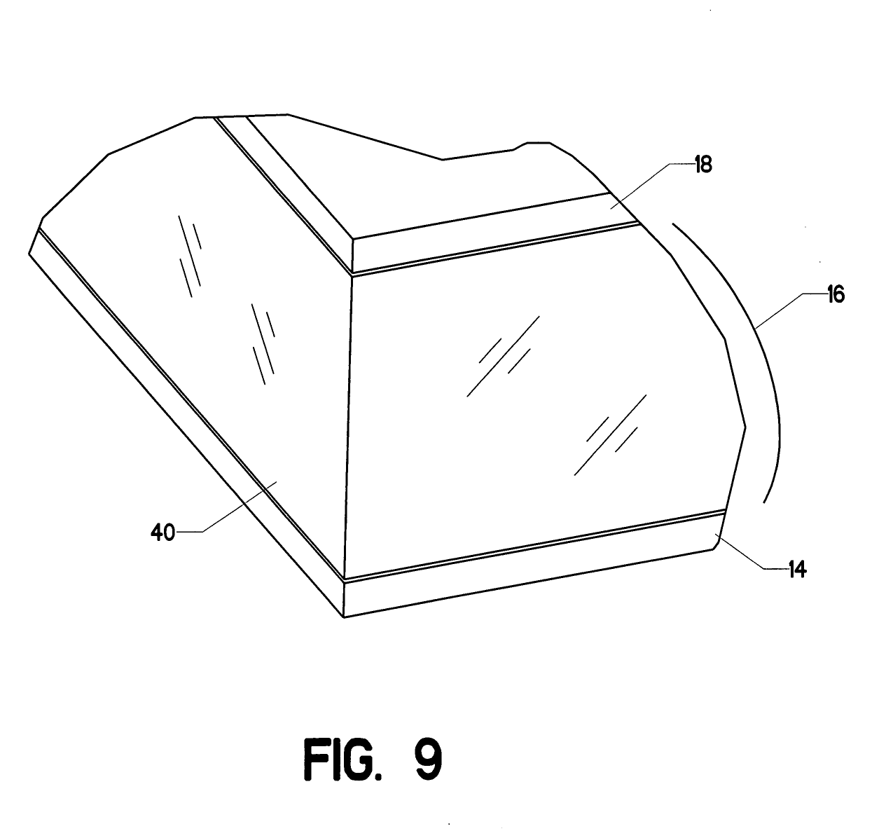

Certain types of rigid porous foams can be substituted for the honeycomb matrix. FIG. 9 shows a composite structure using such a foam for the core layer. Porous foam 40 is sandwiched between inner layer 14 and outer layer 18. It therefore forms core layer 16, as for the prior examples. The porous foam is typically a structure made of open or closed cells. The cells are too small to be individually visible in the view. Ceramic foams—such as boron carbide foams—have excellent mechanical properties. They typically have open cells.

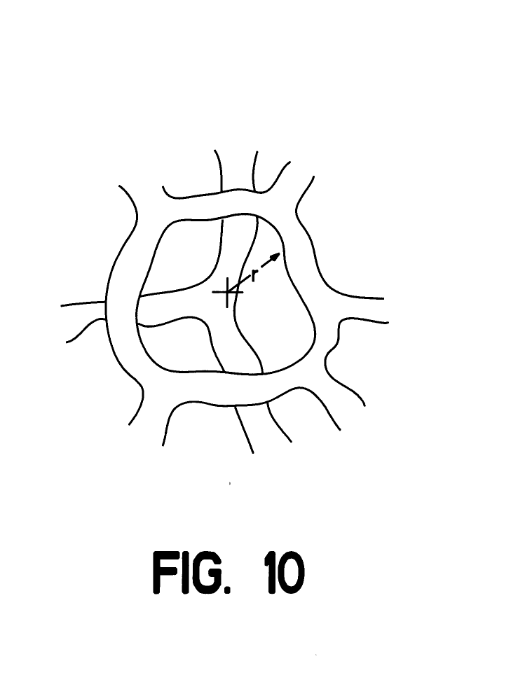

FIG. 10 shows a magnified cross section through the foam. Numerous foam pores 42 are found throughout the structure. These are irregularly shaped voids. The structure is cellular, in that each void can be viewed as a cell bounded by a surrounding wall (in the case of a closed cell) or surrounding ribs (in the case of an open cell). The ribs or walls comprise a relatively small portion of the overall volume. The manufacturing process can control the average size and distribution of the pores.

The theoretical elastic properties for rigid foams at small deformations can be calculated as:

$${E}_{f} \approx {{E}_{m} [ \frac{{ρ}_{f}}{{ρ}_{m}} ]}^{2} , {μ}_{f} \approx \frac{1}{3} ,$$

where E_{f}, ρ_{f}, and μ_{f} are the modulus of elasticity, the density, and Poisson's ratio of the foam (respectively), and Eₘ, ρₘ, and μₘ are the modulus of elasticity, the density, and Poisson's ratio for the material of which the foam is made (in a solid, non-foam state).

When the boron carbide foam is combined with face sheets made of boron carbide ceramic, a safety factor as high as 5.20 can be obtained for ρ_{f}≈89.4 kg/m³, hₗ′≈4.16·10⁻⁵, h₃′≈2.24·10⁻³ (even allowing for a 5% payload). When silicone carbide foam is used as the core, and the face sheets are made of silicon carbide ceramic (ρₛ=3200 kg/m³, E₁=430 GPa, μ₁=0.17), a safety factor as high as 3.06 can still be obtained (ρ_{f}≈65.4 kg/m³, h₁′≈4.10·10⁻⁵, h₃′≈1.73·10⁻³). The result for silicon carbide is obviously inferior, but those skilled in the art will know that silicon carbide is cheaper and easier to manufacture than boron carbide.

The problem of intracell buckling must also be addressed when using rigid foam for the core layer. A formula derived from the theoretical result for hexagonal cells was previously presented for the minimum shell radius R providing stability against intracell buckling. This formula was:

$${R}^{2} = 0.182 ( 1 - {μ}^{2} ) \frac{{P}_{a}}{{E}_{s}} \frac{{r}^{2}}{{( {h}_{1}^{′} )}^{3}}$$

The same formula, although derived for regular hexagonal cells, can be reasonably used to obtain estimates for the foam, where r is the circumradius of the foam pore (shown in FIG. 10). Of course, unlike the case of the hexagonal matrix, the circumradius will not be the same for all the foam pores. For a foam, it is appropriate to compute the largest allowable pore size in order to prevent intracell buckling. Other pores may then be smaller, provided that the overall average pore size does not become so small that the foam's density becomes too high.

For a vacuum balloon having a radius of 0.1 meters using a boron carbide foam sandwiched between two boron carbide face sheets, the largest radius of the foam pores which can be allowed while still providing stability against intracell buckling is approximately 160 micrometers. The average pore size should obviously be smaller in order to be significantly smaller than the core thickness (approximately 220 micrometers) and to provide an appropriate safety factor.

It is possible to generalize the design constraints inherent in the present invention. First, the inner layer and outer layer should have comparable mass, and each of them should be made of a material having a high compressive strength and a high ratio of the compressive modulus of elasticity to the square of the density. Exemplary materials include beryllium, boron carbide, diamond-like carbon, or high-modulus aluminum alloys containing beryllium and magnesium.

Second, the core layer should be a lightweight cellular material having the following properties:
1. compressive strength values in the transverse (radial) direction of at least the same order of magnitude as the atmospheric pressure; and
2. out-of-plane shear strength values of at least the same order of magnitude as the atmospheric pressure.

The core layer material should also have a relatively high compressive modulus of elasticity in the transverse direction and relatively high out-of-plane shear modulus values.

Third, the thicknesses of the inner layer, core layer, and outer layer must satisfy the following conditions: The value for the expressions

$$2 {E}_{1} \frac{{h}_{1} {h}_{3}}{{R}^{2}} and 2 {E}_{2} \frac{{h}_{2} {h}_{3}}{{R}^{2}}$$

must be at least of the same order of magnitude as the atmospheric pressure. The value for the expressions

$${[ 16 {E}_{c}^{2} \frac{{E}_{1}}{1 - {μ}_{1}^{2}} ]}^{1 / 3} \frac{{h}_{1}}{R} {and [ 16 {E}_{c}^{2} \frac{{E}_{2}}{1 - {μ}_{2}^{2}} ]}^{\frac{1}{3}} \frac{{h}_{2}}{R}$$

must likewise be at least of the same order of magnitude as the atmospheric pressure (These four expressions constitute four condition restraints). The symbols used in the condition restraints stand for the following: (1) R is the radius of the shell; (2) h₁ is the thickness of the inner layer; (3) h₂ is the thickness of the outer layer; (4) h₃ is the thickness of the core layer; (5) μ₁ is the Poisson's ration for the inner layer material; (6) μ₂ is the Poisson's ratio for the outer layer material; (7) E₁ is the modulus of elasticity for the inner layer material; (8) E₂ is the modulus of elasticity for the outer layer material; and (9) E_{c} is the modulus of elasticity for the core material in the transverse direction.

Of course, once can observe from the preceding equations that they can be satisfied by simply making h₁ and h₂ very large. The second overarching constraint of buoyancy, however, dictates that h₁ and h₂ should be made as small as possible. The buoyancy equation is:
4πR²(h₁ρ₁+h₂ρ₂+h₃ρ_{c})< 4/3πR³ρₐ

The left side of this equation is the mass of the composite spherical structure, while the right side is the mass of the air the structure displaces. Obviously, the left side must be less than the right side if positive buoyancy is to be achieved. The values for the thickness of the inner layer, outer layer, and core layer must be made as small as possible while still maintaining adequate stability against buckling. These two competing constraints (buckling stability versus the need for positive buoyancy) define a range which is critical.

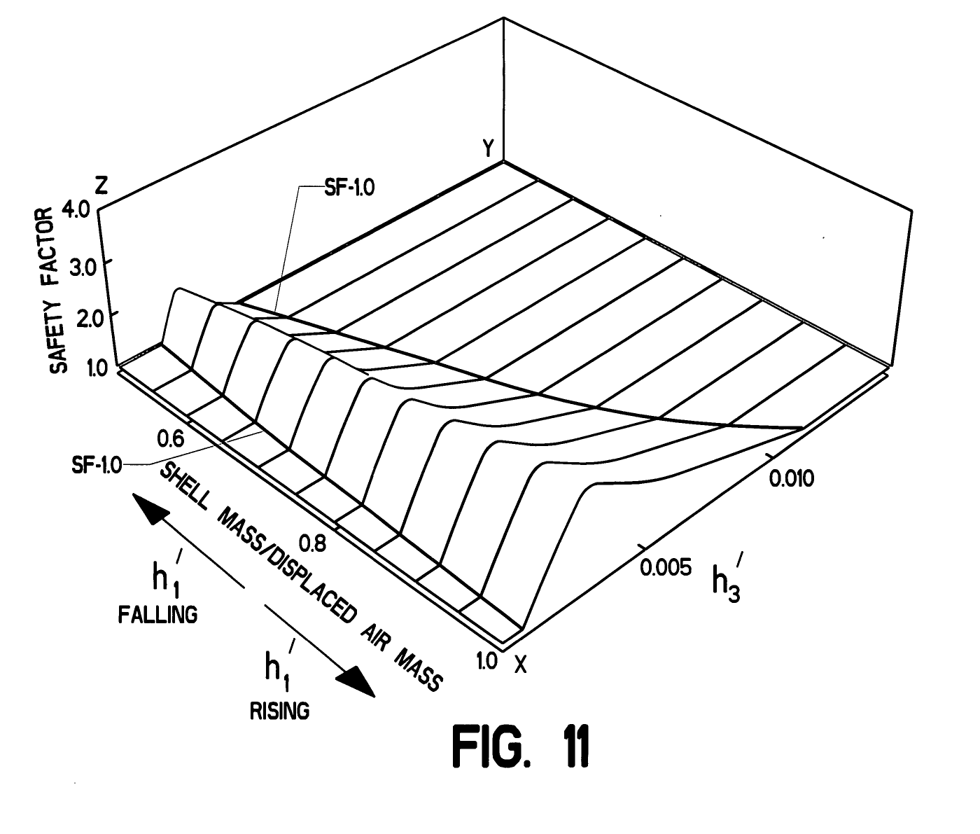

FIGS. 11, 12, and 13 illustrate the criticality of the optimization (for the example of beryllium face sheets and aluminum honeycombs), where one seeks to balance buckling stability against the goal of positive buoyancy. FIG. 11 is a three-dimensional plot. The shell mass to displaced air mass ratio is plotted along the “X” axis. When this ratio is 1.0, the structure achieves neutral buoyancy. When the ratio falls below 1.0, the structure becomes positively buoyant. The plot shows a range of about 0.55 to 1.00. Thus, all points within the plot are positively buoyant or neutral.

The safety factor is plotted along the “Z” axis. Thus value represents the ratio of the critical buckling pressure for the structure to the atmospheric pressure. This value must be at least 1.0 for the structure to exist in a stable state. Obviously, higher values are needed. As mentioned previously, the CODAP standard requires a safety factor of at least 3.0. The plot shows values between 1.0 and 4.0.

The value for h₃′ is plotted along the “Y” axis. The reader will recall that h₃′=h₃/R. For a fixed value of h₃′, the only way to reduce the shell mass is to reduce the value for h₁′. The only way to increase the shell mass is to increase the value for h₁′. This is noted on the plot. Moving to the left along the “X” axis is described as “h₁′ falling.” Moving to the right is described as “h₁′ rising.”

The bold line labeled as “SF-1.0” represents the values within the three dimensional plot where the safety factor is exactly equal to 1.0. Any point lying above that line (meaning higher on the “Z” axis) in the plot is therefore stable. The reader will observe that such points form a rather limited region (Note that h₃′ varies in a range that is very narrow compared to unity).

Furthermore, those skilled in the art will know that a vacuum balloon having a safety factor of 1.0 is inherently dangerous. Manufacturing or material imperfections—as well as external forces such as wind gusts—would cause the device to fail. A higher safety factor is needed in order to achieve a viable design.

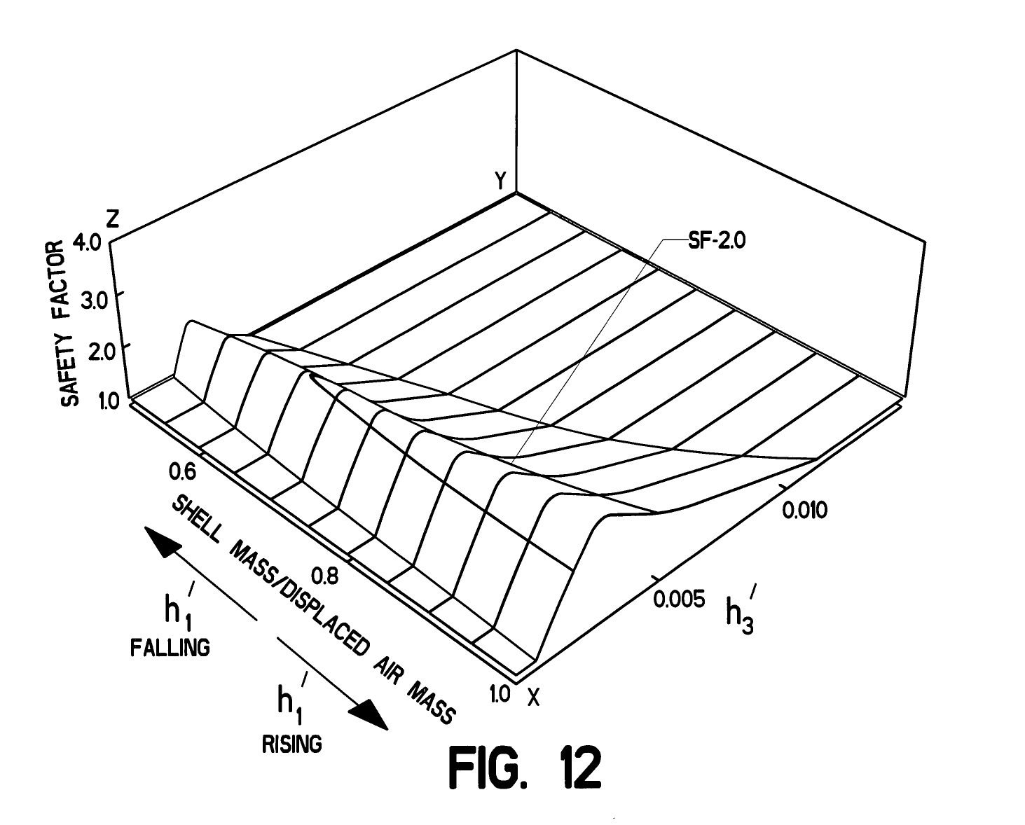

FIG. 12 shows the same plot with a bold line labeled as “SF-2.0.” This line represents the values within the three dimensional plot where the safety factor is exactly equal to 2.0. Any point lying above that line (meaning higher on the “Z” axis) in the plot therefore has a safety factor greater than 2.0. The reader will observe that far fewer points satisfy this condition than was the case for the safety factor of 1.0. And, a safety factor of 2.0 is generally not considered acceptable. A higher ratio is needed, particularly for applications where external mechanical forces will be applied to the vacuum balloon (such as would be the case with an air ship or a simple sphere aloft in the atmosphere).

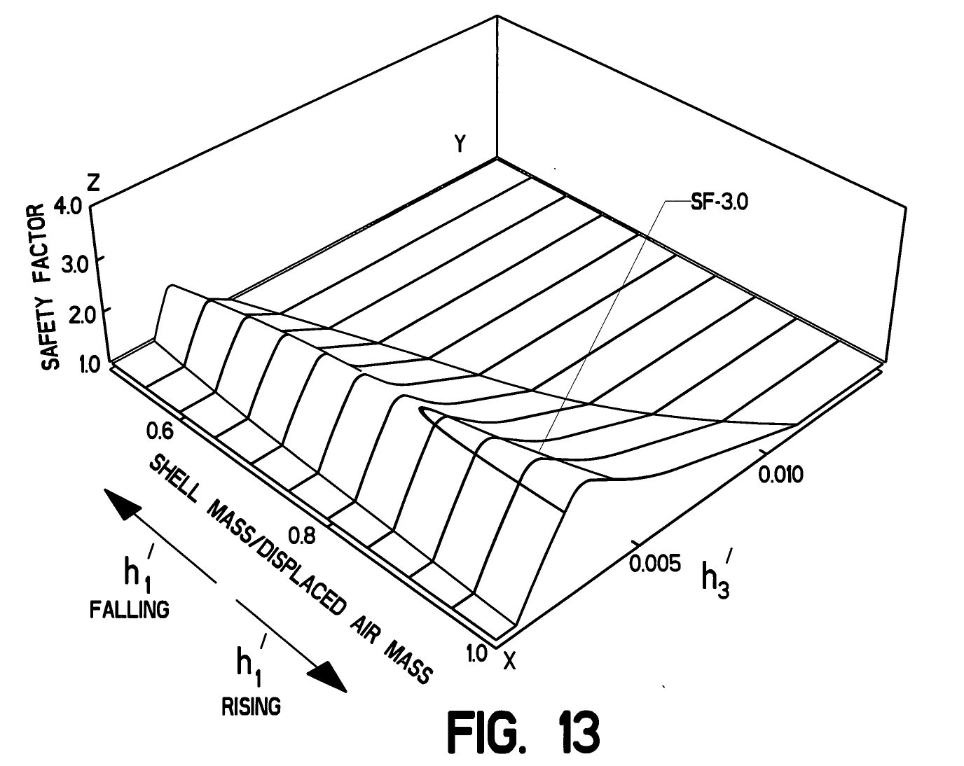

FIG. 13 shows the same plot with a bold line placed along the points where the safety factor equals 3.0. Any point lying higher along the “Z” axis would have a safety factor greater than 3.0. The reader will observe that very few points on the plot satisfy this condition. As the CODAP standard requires a safety factor of at least 3.0, this means that very few combinations can produce a viable design.

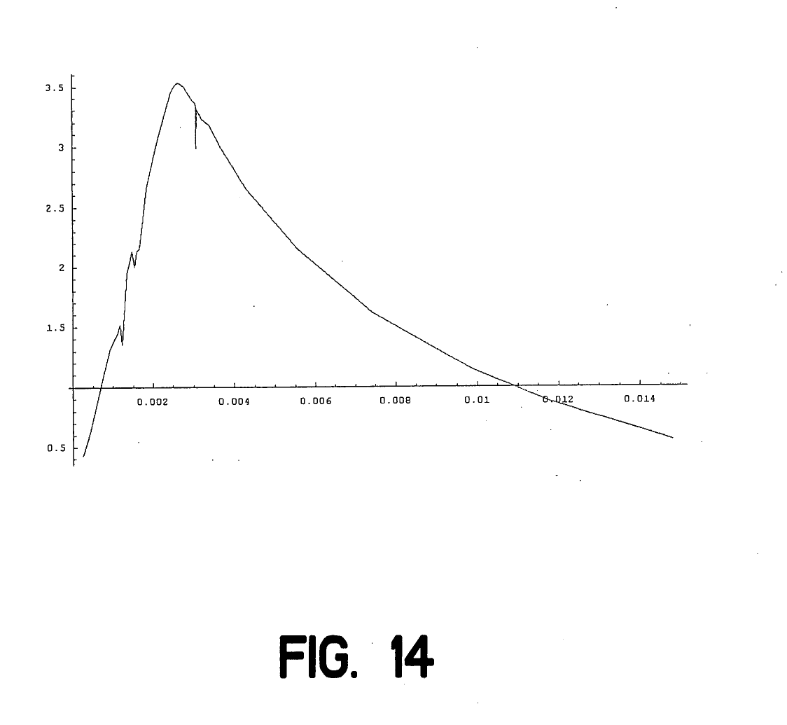

FIG. 14 shows a two dimensional plot of h₃′ versus the safety factor. In this plot, which was developed using finite element analysis, the thicknesses of the inner and outer face sheets were made equal and set to the value needed for neutral buoyancy of the overall structure. The reader will note the relative sharpness of the maximum in the plot. The key to the optimization is realizing the criticality of the ratio h₃′. It is not obvious that the relative thickness of the core (h₃′) is the result-effective parameter rather than the absolute core thickness (h₃) and radius of the shell (R) taken separately. In other words, it is not obvious that the design is scalable with respect to both stress and buckling (if it is stable against intracell buckling). Multiplication of all linear dimensions by the same factor gives an equally viable design. Such scalability does not hold for prior art helium-filled balloons or for prior art composite structures. The reader should note that the buoyancy equation provides a strict relationship between h₃′ and h₁′. Thus, the value for h₁′ could be optimized as well.

The reader should also note that the graphical depictions shown in FIGS. 11-13 are slightly simplified. In actuality the three dimensional surface produced in the plot would have more undulations and complexity. However, these figures serve to illustrate the concepts of the optimization and are generally accurate.

The inner and outer layers are assumed to be reliably bonded to the core layer. All three layers must be precisely manufactured so that manufacturing imperfections do not invalidate the buckling stress analysis discussed previously.

Examples of the above condition restraints may be useful. Standard atmospheric pressure at sea level is 101,325 Pa. Assuming a vacuum balloon with a radius of 1 m and face sheets made of beryllium and an aluminum honeycomb core, the following optimized values were given above: h₃=h₃′R≈2.77·10⁻³ m and h₁=h₁′R≈1.04·10⁻⁴ m. Beryllium has a modulus of elasticity of 303 GPa. The expression

$$2 {E}_{1} \frac{{h}_{1} {h}_{3}}{{R}^{2}}$$

then solves as

$$\frac{2 \cdot 303 \cdot {10}^{9} N \cdot {m}^{- 2} \cdot 1.04 \cdot {10}^{- 4} m \cdot 2.77 \cdot {10}^{- 3} m}{{1}^{2} {m}^{2}} \approx 175 \text{,} 000 Pa .$$

The reader will note that the units of the expression are “pressure” units (Newtons per square meter, or Pascals). These are the same units as for atmospheric pressure. Thus, the reader will understand that the magnitude of this expression can be compared to the magnitude of the atmospheric pressure to see if the value for the expression is at least of the same order of magnitude as the atmospheric pressure. In the example given, the expression produces a result which is of the same order of magnitude as the atmospheric pressure (175,000 Pa compared to 101,325 Pa). Thus, that particular constraint is satisfied.

The units for the four constraint expressions are all pressure units. The values can all be compared to the magnitude of the atmospheric pressure in order to determine whether the constraints are satisfied. Another way of stating the constraint is that the value for

$$2 {E}_{1} \frac{{h}_{1} {h}_{3}}{{R}^{2}}$$

must be greater than or equal to one-tenth of the atmospheric pressure.

The reader may wish to see examples of solutions using the constraint equations. For this example, the inner and outer face sheets have the same thickness and are made of the same material (E₁=E₂, h₁=h₂, etc.). One can define a more narrow range within the range defined by the previously presented constraints (more narrow than simply defining the parameters as having the same order of magnitude as the atmospheric pressure). It is useful to define variables α and β in order to group some terms in the creation of the more narrow constraints. These are defined in the following:

$${h}_{1}^{′} {h}_{3}^{′} > \frac{{P}_{a}}{2 {E}_{1}} = α \qquad ( Equation 5 )$$

$${h}_{1}^{′} > \frac{{P}_{a}}{{[ 16 {E}_{c}^{2} \frac{{E}_{1}}{1 - {μ}_{1}^{2}} ]}^{\frac{1}{3}}} = β \qquad ( Equation 6 )$$

$$2 {h}_{1}^{′} {ρ}_{1} + {h}_{3}^{′} {ρ}_{c} < \frac{1}{3} {ρ}_{a} \qquad ( Equation 7 )$$

The two variables defined (α, β) do not depend on h₁′ or h₃′. One can next introduce definitions for the relative densities, as follows:

$${ρ}_{1}^{′} = \frac{{ρ}_{1}}{{ρ}_{a}} , \\ {ρ}_{c}^{′} = \frac{{ρ}_{c}}{{ρ}_{a}}$$

Points in plane h₁′, h₃′, satisfying the above inequalities, form areas limited by a hyperbola (Equation 5) and straight lines (Equations 6 and 7). If one calculates the abscissas of the points of intersection of the hyperbola h₁′ h₃′=α and the straight line of Equation 7, then Equation 7 may be rewritten as:
6h₁′ρ₁′+3h₃′ρ_{c}′=1 (Equation 8)

If one then substitutes

$$\frac{α}{{h}_{1}^{′}}$$

for h₃′ in Equation 8, one obtains the following quadratic equation:
6ρ₁′(h₁′)²−h₁′+3ρ_{c}′α=0 (Equation 9)

This equation has the well-known solutions for a quadratic:

$$\frac{1 \pm \sqrt{1 - 72 {ρ}_{1}^{′} {ρ}_{c}^{′} α}}{12 {ρ}_{1}^{′}}$$

Solutions only exist when 72ρ₁′ρ_{c}′α<1 and

$$β < \frac{1 + \sqrt{1 - 72 {ρ}_{1}^{′} {ρ}_{c}^{′} α}}{12 {ρ}_{1}^{′}} ,$$

and h₁′ lies in an appropriate range. That range is defined is defined as follows:

$$max ( \frac{1 - \sqrt{1 - 72 {ρ}_{1}^{′} {ρ}_{c}^{′} α}}{12 {ρ}_{1}^{′}} , β ) < {h}_{1}^{′} < \frac{1 + \sqrt{1 - 72 {ρ}_{1}^{′} {ρ}_{c}^{′} α}}{12 {ρ}_{1}^{′}} \qquad ( Equation 10 )$$

Equation 10 can be used to solve for the ranges where beryllium face sheets are bonded to a PLASCORE PAMG-XR1 1.0-3/8-0007-5056 aluminum honeycomb core. This gives:

α≈1.7·10⁻⁷, β≈2.6·10⁻⁵, ρ₁′≈1430, ρ_{c}′≈12.4, 72 ρ₁′ρ_{c}′α≈0.21<1,

$$β > \frac{1 - \sqrt{1 - 72 {ρ}_{1}^{′} {ρ}_{c}^{′} α}}{12 {ρ}_{1}^{′}} \approx 6.6 \cdot {10}^{- 6} , \\ β < \frac{1 + \sqrt{1 - 72 {ρ}_{1}^{′} {ρ}_{c}^{′} α}}{12 {ρ}_{1}^{′}} \approx 1.1 \cdot {10}^{- 4} ,$$

which defines a rather narrow range for h₁′. Specifically, 2.6·10⁻⁵<h₁′<1.1·10⁻⁴. Equation 5 can then be used to solve for h₃′, which solves as 1.5·10⁻³<h₃′<2.1·10⁻².

Comparison with FIG. 14 shows that the above inequalities (Equations 5-7) give reasonably accurate and narrow limits for the range of h₃′ yielding sufficiently high values of the safety factor. Of course, one should choose values lying within these ranges that will give the highest possible safety factors.

The vacuum balloon, having a rigid structure, has numerous advantages over prior art flexible helium or hydrogen containing balloons. As an example, the buoyancy of the vacuum balloon can be regulated without the need to carry ballast. To decrease lift, a valve in the shell can be opened to bleed some air into the evacuated interior. To increase lift, a vacuum pump can be carried to evacuate air from within the interior, possibly through the same valve. This is not to say that conventional ballasting techniques, such as carrying water tanks or ballonets, cannot be used with some advantage in the present invention. Those skilled in the art will realize, however, that a vacuum balloon is not so dependent on separate ballasting devices.

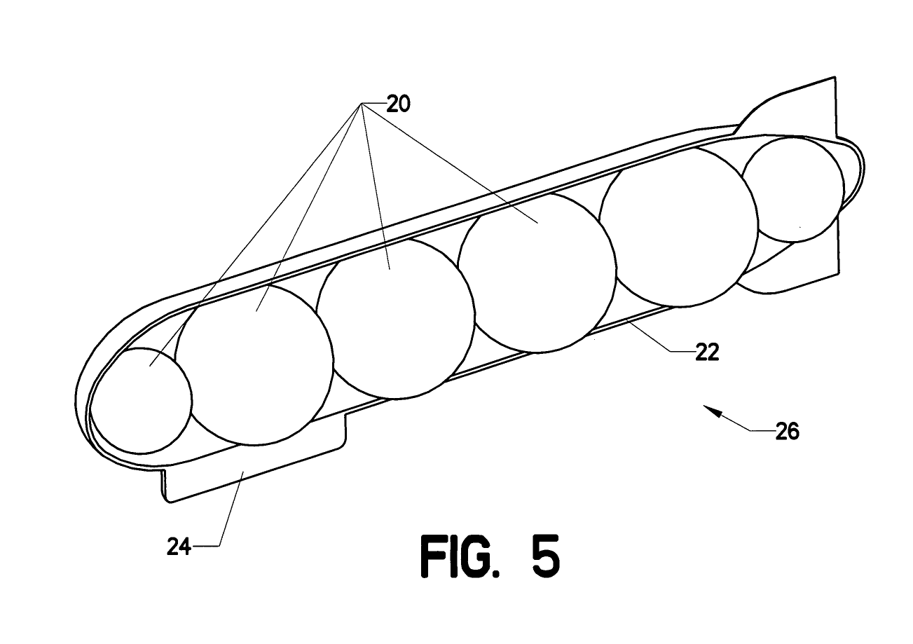

Many applications for the vacuum balloon technology are possible. FIG. 5 shows one such application—air ship 26. Air ship 26 uses five layered vacuum balloons 20. The size of the balloons is adjusted to fit within fuselage 22. A payload compartment 24 is included to house the useful load. An air ship could also be constructed using clusters of much smaller layered vacuum balloons. Such a design could reduce the risk of catastrophic failure, since any structural flaw would only be likely to compromise a small portion of the available lift.

Vacuum balloons constructed according to the present invention can be used in most other applications currently being served by conventional balloons. Examples include toys, lifting devices for advertising banners, lifting devices for broadcasting equipment, and lifting devices for surveillance equipment.

Vacuum balloons do typically have a higher structural weight than conventional inflatable balloons, which may limit the range of altitudes in which a vacuum balloon can operate. This limitation can be overcome to a large degree, however, using a variety of techniques.

To be able to achieve higher altitude, a vacuum balloon may be partially filled with air at low altitude. This would reduce the differential pressure (external versus internal) that the balloon would need to withstand. In the course of ascent, this air should be pumped out. An example serves to demonstrate the advantage of this approach: Assume a shell with boron carbide face sheets (h₃′≈7.53·10⁻⁴, h₁′≈2.51·10⁻⁵, the average density is 0.412 kg·m⁻³). The buckling analysis gives the eigenvalue λₘᵢₙ=0.83. The air density and pressure at the altitude of 10 km are 0.412 kg·m⁻³ and 2.64·10⁴ Pa, respectively (1976 standard atmosphere). Thus, the shell will float and withstand this reduced pressure with a safety factor of 3.18. However, the safety factor depends on the altitude, and it is the minimum value that matters. At normal conditions the shell should be partially filled with air so that it has near-zero buoyancy, and the safety factor is about 2.59 (the minimum value). Thus, the shell may ascend from 0 to 10 km without failure if the air is pumped out so that near-zero buoyancy is maintained. In the emergency case of an accidental descent to lower altitude (such as might result from descending air currents), the pressure inside the balloon could be appropriately increased by quickly bleeding some air in.

On the other hand, a vacuum balloon optimized for high altitudes does not necessarily have to satisfy the requirements of sufficient structural strength and positive buoyancy at all intermediate altitudes. Such balloons may be elevated to the operational altitude using some auxiliary means (with stabilizing internal pressurization being present until it is no longer needed). For example, it is possible to ensure structural strength and positive buoyancy at intermediate altitudes by partially filling the balloons with air and heating the air. In contrast to conventional hot-air balloons, heating would only be required during ascent and descent. No heating would be required at the operational altitude.

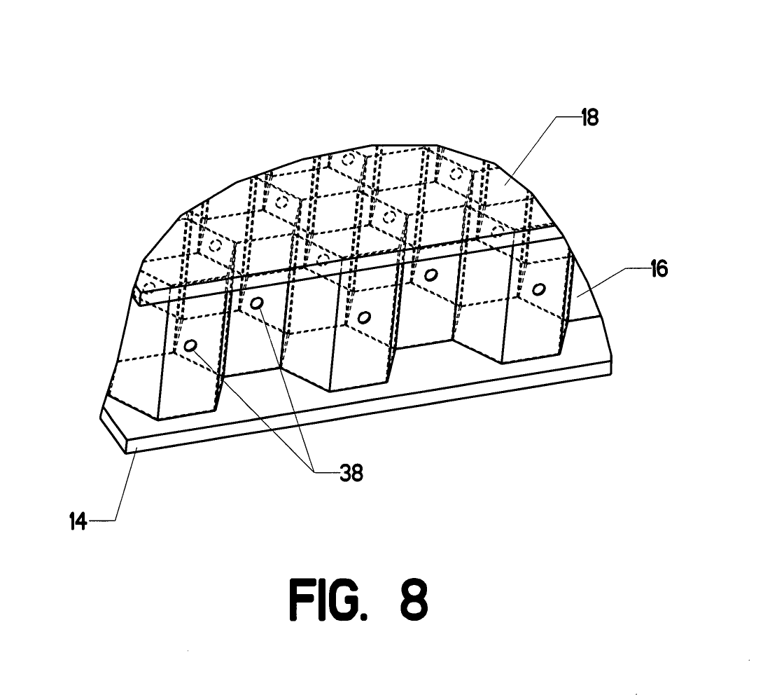

A high-altitude vacuum balloon could also be elevated using sturdier, low-altitude vacuum balloons, helium balloons, or other means. Again, structural strength at intermediate altitudes may be ensured by partially filling the balloon with air. It should be noted that in this case it may be necessary to partially fill the honeycombs with air as well, so honeycombs with perforated cell walls may be needed to enable rapid pressure equilibrium among all the honeycomb cells. FIG. 8 shows one such embodiment, in which the honeycomb walls include a series of vents 38 connecting the honeycomb cells. All these cells can then be connected to a regulation valve which regulates the pressure within the core layer.

An example of a vacuum balloon optimized for high altitudes may be helpful. A shell having beryllium face sheets could be constructed with the following properties: h₃′≈1.058·10⁻³, h₁′≈6.790·10⁻⁶, average density of 0.126 kg·m⁻³. The buckling analysis for this structure produces the minimum eigenvalue λₘᵢₙ=0.095. For an altitude of 18 km, the air density and pressure are 0.126 kg·m⁻³ and 7.51·10³ Pa, respectively (based on the 1976 standard atmosphere). In these conditions, the shell will float and withstand the reduced atmospheric pressure with a safety factor of 1.28.

This safety factor is admittedly not very high, but the structure can be further optimized to improve the margin. Thus, this analysis demonstrates that vacuum balloons may operate at a maximum altitude of at least 18 km. This altitude is attractive for surveillance applications, as wind speeds are relatively low, there is no commercial air traffic, and the balloons may be less vulnerable to attack. The vulnerability may be further reduced by using several vacuum balloons clustered together.

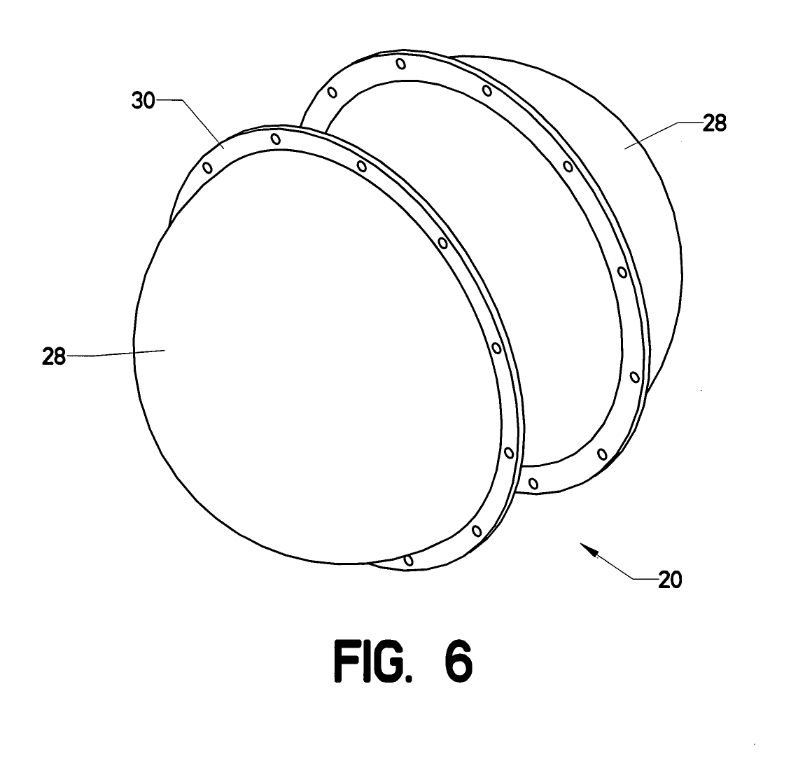

Engineering challenges are present regarding the manufacturing of the vacuum balloons. One approach would be to manufacture a balloon as two halves. The two halves would then be mated and the interior evacuated to the desired level of vacuum. FIG. 6 shows one such design. Two balloon halves 28 mate together along mating flange 30. A sealing gasket or gaskets is provided. The two halves can be bolted or otherwise joined together to form a completed vacuum balloon.

This approach also allows much more efficient storage, since a stack of nested balloon halves would not create much dead volume. Such an approach cures one problem inherent with helium-filled lifting devices: helium-filled airships occupy a very large volume and must consequently be stored in large hangars. Alternative solutions for helium airships (such as venting helium to the atmosphere or pressurizing helium and pumping it into high-pressure cylinders) are expensive.

Disassembling the balloon and storing the balloon halves is much simpler. A bleed valve is opened which allows the balloon to fill with air up to atmospheric pressure. The balloon can then be disassembled into two halves and the latter can be stacked for storage. When the balloon is again needed, it is reassembled from the two halves and a vacuum pump is used to evacuate most of the air contained in the internal volume. The same approach could be used for spherical balloons divided into three, four, or more sections.

Other manufacturing methods are possible. For a shell having a small radius, inner and outer layers would be quite thin. These layers could be formed using deposition methods (which would include vapor deposition and many other techniques). For larger radius shells, gelcasting techniques can be employed. In particular, within this technology and using, e.g., foaming agents, thin spherical layers may be blown similar to glass ones.

And, the reader should bear in mind that a relatively conventional material was used for the analysis of the honeycomb core embodiment (5056 aluminum alloy). A shell with a honeycomb made of more exotic materials—such as a high modulus aluminum-beryllium-magnesium alloy—should withstand even higher pressure.

As described previously, the structure disclosed using the more efficient embodiments will not lose a significant part of the useful lifting force even using “rough” vacuum (around 0.01 atmospheres; somewhat less for higher altitudes), which can be achieved with simple vacuum pumps at low cost.

Traditional gas balloons suffer from greatly variable buoyancy depending on the atmospheric conditions. The gas contained expands and contracts under changing atmospheric conditions (such as bright sunlight or rain). The structure disclosed by the present invention could also be used to contain helium at a pressure close to atmospheric pressure. A much weaker wall section can be used, since it would not be required to resist the crushing force of atmospheric pressure. The structure would only need to be strong enough to maintain the same balloon size despite increasing and decreasing internal pressure. Thus, the structure disclosed is useful for applications other than operations at near-vacuum.

The preceding description contains significant detail regarding the novel aspects of the present invention. It should not be construed, however, as limiting the scope of the invention but rather as providing illustrations of the preferred embodiments of the invention. As an example, the Grid-Lock technology disclosed in U.S. Pat. No. 5,273,806 could be substituted for the conventional honeycomb cells in the core layer. Many other such substitutions are possible. Thus, the scope of the invention should be fixed by the following claims rather than the examples given.

Having described our invention, we claim:

1. A structure for creating buoyancy within an atmosphere having an atmospheric pressure and an air density ρₐ, comprising:
a. a sealed spherical shell, with an enclosed volume contained therein;
b. wherein said spherical shell includes,
i. an inner layer proximate said enclosed volume,
ii. an outer layer distal to said enclosed volume,
iii. a core layer between said inner layer and said outer layer;
c. wherein said inner layer, said outer layer, and said core layer are all bonded together;
d. wherein said inner layer and said outer layer have approximately the same mass;
e. wherein said core layer is substantially thicker than said inner layer and said outer layer;
f. wherein said core layer includes a plurality of adjoining cells;
g. said spherical shell has a radius R;
h. said inner layer has a thickness h₁, a thickness to shell radius ratio h₁′=h₁/R, a modulus of elasticity E₁, a Poisson's ratio μ₁, and a density ρ₁;
i. said outer layer has a thickness h₂, a thickness to shell radius ratio h₂′=h₂/R, a modulus of elasticity E₂, a Poisson's ratio μ₂, and a density ρ₂;
j. said core layer has a thickness h₃, a thickness to shell radius ratio h₃′=h₃/R, a modulus of elasticity in the transverse direction E_{c}, and a density ρ_{c};
k. wherein materials are selected for said inner layer, said outer layer, and said core layer, and values for said h₁′, h₂′, and h₃′ are selected such that they lie within a range wherein,
i. 2E₁h₁′h₃′ is at least the same order of magnitude as said atmospheric pressure,
ii. 2E₂h₂′h₃′ is at least the same order of magnitude as said atmospheric pressure,
iii.
$${[ 16 {E}_{c}^{2} \frac{{E}_{1}}{1 - {μ}_{1}^{2}} ]}^{\frac{1}{3}} {h}_{1}^{′}$$
is at least the same order of magnitude as said atmospheric pressure,
iv.
$${[ 16 {E}_{c}^{2} \frac{{E}_{2}}{1 - {μ}_{2}^{2}} ]}^{\frac{1}{3}} {h}_{2}^{′}$$
is at least the same order of magnitude as said atmospheric pressure; and
v. h₁′ρ₁+h₂′ρ₂+h₃′ρ_{c} is less than ⅓ ρₐ.

2. A structure as recited in claim 1, wherein:
a. said inner layer is made of a material selected from the group consisting of beryllium, boron carbide ceramic, and diamond-like carbon; and
b. said outer layer is made of a material selected from the group consisting of beryllium, boron carbide ceramic, and diamond-like carbon.

3. A structure as recited in claim 2, wherein said adjoining cells in said core layer are made of aluminum.

4. A structure as recited in claim 1, wherein said adjoining cells are hexagonal.

5. A structure as recited in claim 1, wherein said adjoining cells have four sides.

6. a structure as recited in claim 1, wherein:
a. said sealed spherical shell is divided into two separate hemispheres; and
b. each of said two separate hemispheres includes attachment features so that said two separate hemispheres can be fastened together to form said sealed spherical shell.

7. A structure as recited in claim 1, further comprising a valve in said sealed spherical shell for adjusting said pressure of gas contained within said enclosed volume.

8. A structure as recited in claim 1, wherein said inner and outer layer are made from materials having high values of compressive strength and high ratios of the compressive modulus to the square of the density.

9. A structure as recited in claim 1, wherein said core layer is made from a material having a high compressive modulus of elasticity in the transverse direction and a high out-of-plane shear modulus.

10. A structure as recited in claim 1, wherein said sealed spherical shell is divided into at least two subsections which can be fastened together to form said sealed spherical shell.

11. A structure as recited in claim 7, further comprising a vacuum pump connected to said valve, capable of pulling said gas within said enclosed volume out of said structure and ejecting said gas to said atmosphere.

12. A structure as recited in claim 1, wherein said core layer includes a plurality of vents connecting said plurality of adjoining cells.

13. A structure as recited in claim 1, wherein the radius of said shell is large enough to prevent intracell buckling.

14. A structure as recited in claim 1, wherein:
a. 2E₁h₁′h₃′ is greater than said atmospheric pressure;
b. 2E₂h₂′h₃′ is greater than said atmospheric pressure;
c.
$${[ 16 {E}_{c}^{2} \frac{{E}_{1}}{1 - {μ}_{1}^{2}} ]}^{\frac{1}{3}} {h}_{1}^{′}$$
is greater than said atmospheric pressure; and
d.
$${[ 16 {E}_{c}^{2} \frac{{E}_{2}}{1 - {μ}_{2}^{2}} ]}^{\frac{1}{3}} {h}_{2}^{′}$$
is greater than said atmospheric pressure.

15. A structure as recited in claim 14, wherein:
a. said inner layer is made of a material selected from the group consisting of beryllium, boron carbide ceramic, and diamond-like carbon; and
b. said outer layer is made of a material selected from the group consisting of beryllium, boron carbide ceramic, and diamond-like carbon.

16. A structure as recited in claim 15, wherein said adjoining cells in said core layer are made of aluminum.

17. A structure as recited in claim 14, wherein said adjoining cells are hexagonal.

18. A structure as recited in claim 14, wherein said adjoining cells have four sides.

19. A structure as recited in claim 1, wherein said adjoining cells are formed using a porous foam.

20. A structure as recited in claim 14, wherein said adjoining cells are formed using a porous foam.

21. A structure as recited in claim 19, wherein said porous foam is an open-celled foam.

22. A structure as recited in claim 19, wherein said porous foam is a closed-cell foam.

23. A structure as recited in claim 20, wherein said porous foam is an open-celled foam.

24. A structure as recited in claim 20, wherein said porous foam is a closed-cell foam.
